(19) United States
(12) Patent Application Publication
(10) Pub. No.: US 2024/0362890 A1
(43) Pub. Date: Oct. 31, 2024

(54) DATA PROCESSING METHOD AND DEVICE

(71) Applicant: Smarter Silicon (Shanghai) Technologies Co., Ltd., Shanghai (CN)

(72) Inventors: Linlin CHEN, Shanghai (CN); Liang HE, Shanghai (CN)

(21) Appl. No.: 18/630,742

(22) Filed: Apr. 9, 2024

(30) Foreign Application Priority Data
Apr. 27, 2023 (CN) 202310476693.0

(51) Int. Cl. G06V 10/46; G06T 5/50; G06T 7/00; G06T 7/11; G06T 9/00

(52) U.S. Cl. CPC G06V 10/462; G06T 5/50; G06T 7/0002; G06T 7/11; G06T 9/00; G06T 2207/20221; G06T 2207/30168

(57) ABSTRACT

A data processing method includes: obtaining at least one frame of an original image; performing visual saliency detection on each frame of the original image in the at least one frame of the original image to obtain visual saliency data of each frame of the original image; performing differential processing on different positions of each frame of the original image to obtain at least one frame of a processed target image based on the visual saliency data; and encoding the processed target image.

### CROSS-REFERENCES TO RELATED APPLICATION

This application claims priority to Chinese Patent Application No. 202310476693.0 filed on Apr. 27, 2023, the entire content of which is incorporated herein by reference.

### FIELD OF TECHNOLOGY

The present disclosure relates to the field of imaging technology and, more specifically, to a data processing method and device.

### BACKGROUND

With the rapid development of multimedia communication technology, demands for better images and videos have increased. To obtain high-quality images and videos, high-pixel cameras are being used, resulting in large amounts of image and video data. In general, these high-quality images or videos can be used in many scenarios such as video conferencing, smart security, and image live broadcasting. Since these scenarios involve the transmission of image or video data, and the transmission of high-quality image or video data requires a large amount of data and is costly with the limited network bandwidth resources, in order to meet the requirements of low cost, high data transmission efficiency and adaptability to network bandwidth, there is a need to compress and encode the original high-quality image or video data. For example, in conventional video conferencing scenarios, due to the low network bandwidth, if the original video data is directly compressed and encoded, the quality of the encoded video will be greatly reduced, thereby affecting the visual experience of the end user.

### SUMMARY

One aspect of this disclosure provides a data processing method. The method includes obtaining at least one frame of an original image; performing visual saliency detection on each frame of the original image in the at least one frame of the original image to obtain visual saliency data of each frame of the original image; performing differential processing on different positions of each frame of the original image to obtain at least one frame of a processed target image based on the visual saliency data; and encoding the processed target image.

Another aspect of the present disclosure provides a data processing device. The device includes an acquisition module, a detection module, a differential processing module, and an encoding module. The acquisition module is configured to obtain at least one frame of an original image. The detection module is configured to perform visual saliency detection on each frame of the original image in at least one frame of the original image to obtain visual saliency data of each frame of the original image. The differential processing module is configured to perform differential processing on different positions of each frame of the original image to obtain at least one frame of a processed target image based on the visual saliency data. The encoding module is configured to encode the processed target image.

### BRIEF DESCRIPTION OF THE DRAWINGS

In order to illustrate the technical solutions in accordance with the embodiments of the present disclosure more clearly, the accompanying drawings to be used for describing the embodiments are introduced briefly in the following. It is apparent that the accompanying drawings in the following description are only some embodiments of the present disclosure. Persons of ordinary skill in the art can obtain other accompanying drawings in accordance with the accompanying drawings without any creative efforts.

FIG. 1 is a flowchart of a data processing method according to an embodiment of the present disclosure.

FIG. 2 is a flowchart of differential processing according to an embodiment of the present disclosure.

FIG. 3 is a flowchart of another differential processing according to an embodiment of the present disclosure.

FIG. 4 is a flowchart of another data processing method according to an embodiment of the present disclosure.

FIG. 5 is a schematic structural diagram of a data processing device according to an embodiment of the present disclosure.

FIG. 6 is a schematic structural diagram of an electronic device according to an embodiment of the present disclosure.

### DETAILED DESCRIPTION

To make the purposes, technical solutions, and advantages of the present disclosure clearer, the present disclosure is further described in detail below in connection with the accompanying drawings. Described embodiments do not limit the present disclosure. All other embodiments obtained by those of ordinary skill in the art without creative efforts are within the scope of the present disclosure.

In the present disclosure, description with reference to the terms “one embodiment,” “some embodiments,” “example,” “specific example,” or “some examples,” etc., means that specific features described in connection with the embodiment or example, structure, material or feature is included in at least one embodiment or example of the present disclosure. Furthermore, the particular features, structures, materials or characteristics described may be combined in any suitable manner in any one or more embodiments or examples. Furthermore, those skilled in the art may combine the different embodiments or examples described in this specification, as well as the features of the different embodiments or examples, as long as they do not conflict with each other.

Unless otherwise defined, all technical and scientific terms used herein have the same meaning as commonly understood by those skilled in the technical field to which the present disclosure belongs. The terms used herein are only for the purpose of describing the embodiments of the present disclosure, and are not intended to limit the scope of the present disclosure.

In some embodiments, the data processing method provided by embodiments of the present disclosure may be implemented by a processor in a data processing device. The processor may include at least one of an application specific integrated circuit (ASIC), a digital signal processor (DSP), a digital signal processing device (DSPD), a programmable logic device (PLD), a field programmable gate array (FPGA), a central processing unit (CPU), controller, microcontroller, or microprocessor.

In the embodiments of the present disclosure, in addition to video conferencing scenario, the usage scenarios of the data processing method can also include smart security, image live broadcast and other related scenarios involving image or video data transmission. The following description takes the video conferencing scenario as an example to describe the data processing method. It should be understood that, especially for the video conferencing scenario, the lit bit rate of video images, the end user's visual effects will be impacted. Therefore, there is a need to provide a data processing method that can optimize the quality of video images to ensure that the quality of the encoded video is improved as much as possible under the condition of bit rate constraints to improve the visual effects of the end users.

FIG. 1 is a flowchart of a data processing method according to an embodiment of the present disclosure. The method will be described in detail below.

101, obtaining at least one frame of an original image.

In the embodiments of the present disclosure, the data processing method can be applied to an electronic device, and the electronic device can obtain one or more frames of original images. The method of obtaining the original image is not limited to the present disclosure. For example, the electronic device may directly obtain the original image of each frame from an external input, or extract each frame of the original image from an original video input externally. In addition, the original image or the original video may be captured by the electronic device itself, the original video may include at least one frame of the original image. In some embodiments, the externally input images and videos may be captured by image acquisition devices such as cameras.

For example, the electronic device may establish a communication connection with a terminal for data exchange. The electronic device may be used to perform a series of processes on each frame of the original image obtained. The process will be described in detail below. In some embodiments, the terminal may be used to display the received processed image for viewing by the end user.

The format of each frame of the original image is not limited in the present disclosure. For example, the format may be a YUV format or other types of formats, and conversion can be performed between different formats. The YUV format refers to a pixel format in which brightness parameters and chrominance parameters can expressed separately, where Y represents brightness, which is the gray value, and U and V represent chroma, which are used to represent the color information of pixels.

In some embodiments, the original image may be a video image. For example, the original image may be a frame taken in a video conference scene including an image of the participants. Alternatively, the original image may be a single image. For example, the original image may be an image including a tourist attraction taken in a live picture scene.

The type and scene of the image is not limited in the present disclosure.

102, performing visual saliency detection on each frame of the original image in at least one frame of the original image to obtain visual saliency data of each frame of the original image.

In some embodiments, visual saliency detection can be used as an important step in image preprocessing, and its purpose is to obtain the visual saliency data of each frame of the original image. The visual saliency data can represent the user's level of interest in each location on the image. Subsequently, based on the visual saliency data, image areas that are of interest to the user can be determined. These areas may only include areas that the user is very interested, or it may also include areas that the user is generally interested in. These areas can be referred to as salient areas. The areas in the original image of each frame other than the salient areas may be referred to as other image areas. These areas may only include areas that the user is not interested in at all, or it may also include areas that the user's slightly interested in. These areas can be referred to as non-salient areas.

It should be noted that various suitable visual saliency detection methods may be used to perform visual saliency detection on the original image. For example, a visual saliency model may be used to perform visual saliency detection on the original image. Based on this, in order to ensure the detection accuracy of the model, the visual saliency model may adopt a visual saliency model based on deep learning.

In some embodiments, performing visual saliency detection on each frame of the original image to obtain the visual saliency data of each frame of the original image may include performing visual saliency detection by inputting each frame of the original image into a pre-trained visual saliency model to obtain the visual saliency data of each frame of the original image.

In some embodiments, the visual saliency model may be trained based on the saliency data set collected by a visual acquisition device and a pseudo-saliency data set. For example, the visual acquisition device may be an eye tracker, or other related devices capable of collecting the characteristics of the user's eye movement trajectory.

In some embodiments, the saliency data set may include a plurality of frames of a first sample image and label information of each frame of the first sample image. The label information may include the significance value of each pixel in the first sample image of each frame, and this value may be used to indicate whether these pixels are significant. Correspondingly, if the saliency value of a certain pixel is greater than or equal to a set value, it may indicate that the pixel is significant; if the saliency value of a certain pixel is less than the set value, it may indicate that the pixel is not significant. It should be noted that if a pixel is salient, it may indicate that the pixel has the ability to attract the user's visual attention; conversely, if the pixel is not salient, it may indicate that the pixel does not have the ability to attract the user's visual attention. In some embodiments, the pseudo-saliency data set may include a plurality of frames of a second sample image, and the label information of each frame of the second sample image may need to be predicted by the visual saliency model.

In some embodiments, the training process of the visual saliency model may include: using the saliency data set to train a pre-built initial visual saliency model to obtain a trained visual saliency model; using the trained visual saliency model to predict the label information of the second sample image of each frame in the pseudo-saliency data set to obtain the predicted label information; retraining the initial visual saliency model based on the saliency data set and the pseudo-saliency data set with the label information to obtain the trained visual saliency model; and storing the trained visual saliency model for subsequent use.

In some embodiments, after the trained visual saliency model is obtained, each frame of the original image acquired by the electronic device may be input into the pre-trained visual saliency model for visual saliency detection to obtain the visual saliency data of each frame of the original image.

In some embodiments, the visual saliency data may include the saliency corresponding to each pixel in each frame of the original image. The saliency corresponding to these pixels may form a saliency image of the original image, that is, the saliency image may include the saliency of each pixel in the original image.

For example, assume that the original image of a certain frame includes 100*100 pixels. After original image detection, the saliency of 100*100 pixels can be obtained, that is, the visual saliency data of the original image can be obtained. Correspondingly, the saliency image of the original image can include the saliency of 100*100 pixels. For example, the saliency of row 1 and column 1 in the saliency image can be the saliency of the pixels in row 1 and column 1 of the original image.

In some embodiments, the saliency image may reflect the salient part of the original image, which can be expressed as a grayscale image. That is, the saliency value of each pixel in the original image of each frame may range from 0 to 255, where a saliency value of 0 is being displayed as black, and a saliency value of 255 is being displayed as white. In general, the greater the saliency value, the higher the saliency.

103, based on the visual saliency data, performing differential processing on different locations of each frame of the original image to obtain at least one processed target image.

In some embodiments, since the visual saliency data includes the saliency of each pixel of each frame of the original image, and the saliency between pixels at different locations in the image is likely to be different, different locations of each frame of the original image may be differentiated based on the visual saliency data such that the saliency distinction of the processed target image can be clearer.

In some embodiments, each frame of the original image acquired can be regarded as any original video image in the video conferencing scenario. In the embodiments of the present disclosure, the corresponding visual saliency data can be obtained by performing visual saliency detection on each frame of the original image, and then the saliency detection data can be used as a guide to perform differential processing on different locations of the original image. For example, image quality enhancement processing may be performed on the area of interest to the user in the original image, that is, the salient area, and no special processing may be performed on other areas, or image quality weakening processing may be performed. In this way, the image quality of the salient area in each frame of the original image can be improved and the visual quality of the encoded image can be ensured, thereby address the reduced image quality after encoding due to low network bandwidth in video conferencing scenarios, and effectively improving the visual experience of end users. The process of differential processing will be described in detail below.

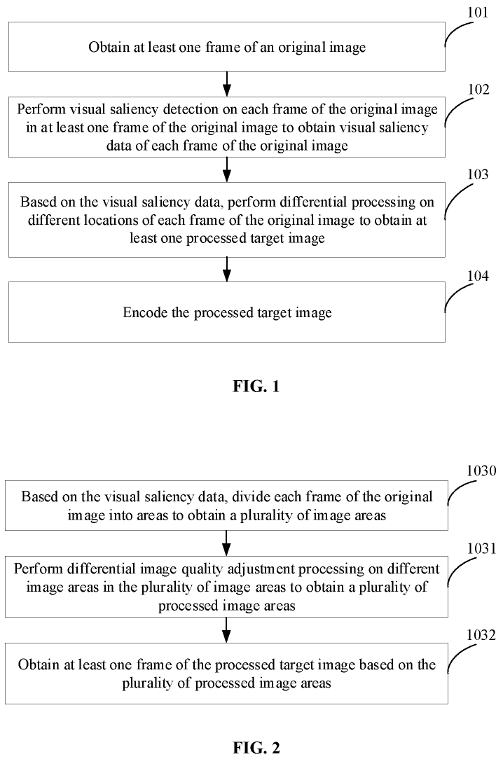

Refer to FIG. 2. In some embodiments, based on the visual saliency data, performing differential processing on different locations of each frame of the original image to obtain at least one frame of the processed target image may include the following steps.

1030, based on the visual saliency data, dividing each frame of the original image into areas to obtain a plurality of image areas.

1031, performing differential image quality adjustment processing on different image areas in the plurality of image areas to obtain a plurality of processed image areas.

1032, obtaining at least one frame of the processed target image based on the plurality of processed image areas.

In some embodiments, corresponding target thresholds may be set for the visual saliency data. The saliency of each pixel in each frame of the original image included in the visual saliency data may be compared with the target threshold to obtain comparison results. When the comparison results shows that the saliency of the pixel is greater than the target threshold, the pixel may be determined to be a salient pixel, which can be referred to as a salient pixel; conversely, when the comparison results shows that the saliency of the pixel is less than or equal to the target threshold, the pixel may be determined to be a non-salient pixel, which can be referred to as a non-salient pixel. In this way, each salient pixel and each non-salient pixel in each frame of the original image can be determined.

Further, each frame of the original image may be divided into areas based on each salient pixel and each non-salient pixel in each frame of the original image to obtain a plurality of image areas. Here, the plurality of image areas may include at least one salient area and other image areas. Due to the regional nature of visual attraction objects, each salient area generally includes multiple connected salient pixels in the original image, and other image areas may be the image areas in the plurality of image areas other than the salient area, corresponding to the non-salient area.

In some embodiments, after obtaining the plurality of divided image areas, performing differentiated image quality adjustment processing on different image areas in the plurality of image areas may include: performing image quality enhancement processing on at least one salient area, and performing image quality weakening processing or no processing on other image areas, the other image areas being each image area other than the salient area in the plurality of image areas.

In other embodiments, a plurality of target thresholds may be set for the visual saliency data. In this way, by comparing the saliency of each pixel in each frame of the original image included in the visual saliency data with the plurality of different target thresholds, the saliency of each pixel in each frame of the original image can be determined. For example, the degree of saliency may include high saliency, medium saliency, low saliency, and no saliency. Further, each frame of the original image may be divided into areas based on the degree of the saliency of each pixel to obtain the plurality of image areas. Here, the plurality of image areas may include a most salient area, a medium salient area, a low salient area, and a non-salient area.

In some embodiments, differentiated image quality enhancement processing may be performed on the most salient area and the medium salient area, the degree of enhancement being positively related to the degree of saliency; and differentiated image quality weakening processing may be performed on the low salient area and the non-salient area, the degree of weakening being negatively related to the degree of saliency. In the following description, the process of performing image quality adjustment processing for a plurality of image areas including at least one salient area and other image areas will be described as an example.

In some embodiments, various suitable enhancement processing techniques may be used to enhance the image quality of each salient area in each frame of the original image. The image enhancement processing technique may include, in addition to enhancement techniques related to sharpening, brightness, chroma, contract, etc., it may also include other enhancement processing techniques such as uneven exposure compensation processing.

For example, for other image areas in each frame of the original image, various suitable image quality weakening techniques may be used in image quality weakening processing, or no processing may be performed. The type of image quality weakening technique is not limited to the embodiments in the present disclosure. For example, the image quality weakening techniques may be related to the brightness, chroma, contract, etc., and no processing means that no processing is performed on other image areas. In some cases, since enhancement processing will increase the bit rate of the salient area, the prerequisite for not processing other areas may be that the difference in image bit rates before and after image quality enhancement processing is less than the set threshold such that the enhanced image can meet the transmission requirement. When network transmission conditions permit, there is no need to consider the difference in image bit rates, and focus can be placed on enhancing the salient area to obtain the best image enhancement effect, while leaving other areas unprocessed.

In the embodiments of the present disclosure, the difference in image bit rate before and after each frame of the original image is differentiated may need to be less than the set threshold. There is no limit to the value of the set threshold, as long as it is ensured that the image bit rate after differentiation meets the network bandwidth requirements, that is, the bit rate constraints are met.

By setting the threshold, the image bit rate before and after differential processing can meet the network bandwidth requirements. In this way, the image quality of each salient area can be improved without affecting the data transmission rate.

It should be noted that after image quality enhancement processing is performed on each salient area in each frame of the original image, if it is determined that the difference in image bit rates before and after the enhancement processing is less than the set threshold, then no processing on each non-salient area in the original image, or image quality weakening processing may be performed on some non-salient areas, or image quality weakening processing may be performed on all non-salient areas. If it is determined that the difference in image bit rates before and after the enhancement processing is greater than or equal to the set threshold, then image quality weakening processing may be performed on some non-salient area, or image quality weakening processing may be performed on all non-salient areas. The purpose of the above processing is to ensure that the difference in image bit rates before and after processing is less than the set threshold, thereby meeting the network bandwidth requirements.

It should be understood that, since the salient area is the area of interest to the end user, image quality enhancement processing may be performed on the salient area, and image quality may be weakened or left unprocessed on the non-salient areas to ensure that the difference in image bit rates before and after processing is less than the set threshold. In this way, the bit rates in the salient area can be increased under the condition of bit rate constraints, thereby ensuring the quality of subsequent encoded image, and improving the visual experience of the end users.

In some embodiments, a plurality of processed image areas may be obtained by performing the above image quality adjustment processing on the plurality of image areas of each frame of the original image, and obtaining at least one frame of processed target image based on the plurality of processed image areas may include: performing image fusion processing on the plurality of processed image areas to obtain at least one frame of fused image, and determining the fused image of each frame as the processed target image.

For example, an image fusion algorithm may be used to perform image fusion processing on the plurality of processed image areas to obtain at least one frame of fused image, and each frame of the fused image may be determined as the processed target image.

The type of image fusion algorithm is not limited in the present disclosure. It should be noted that the image fusion algorithm can also smooth the edges of each image area such that the edge continuity between each image area in the fused image meets the set requirements.

Consistent with the present disclosure, by performing image fusion processing on each image area, the edges of each image area can be smoothed while merging each image area, thereby ensuring the visual continuity of each image area in the fused image and improving the display effect of the image.

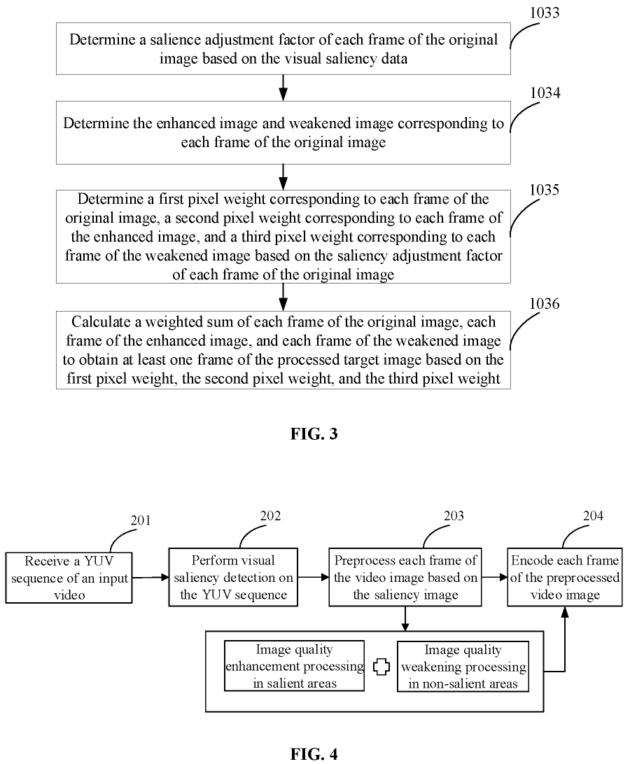

Referring to FIG. 3, in some embodiments, based on the visual saliency data, performing differential processing on different locations of each frame of the original image to obtain at least one frame of the processed target image may include the following steps.

1033, determining a saliency adjustment factor of each frame of the original image based on the visual saliency data.

1034, determining the enhanced image and weakened image corresponding to each frame of the original image.

1035, determining a first pixel weight corresponding to each frame of the original image, a second pixel weight corresponding to each frame of the enhanced image, and a third pixel weight corresponding to each frame of the weakened image based on the saliency adjustment factor of each frame of the original image.

1036, calculating a weighted sum of each frame of the original image, each frame of the enhanced image, and each frame of the weakened image to obtain at least one frame of the processed target image based on the first pixel weight, the second pixel weight, and the third pixel weight.

The saliency adjustment factor of each frame of the original image may represent the saliency adjustment factor corresponding to each pixel in each frame of the original image. For example, the visual saliency data may only include the saliency corresponding to each pixel in each frame of the original image, or may include the saliency corresponding to each pixel in each frame of the original image and the saliency adjustment factor after data preprocessing of the saliency corresponding to each pixel.

For example, if the visual saliency data includes the saliency adjustment factors corresponding to each pixel in each frame of the original image, the saliency adjustment factors of each frame of the original image may be directly obtained based on the visual saliency data. Correspondingly, if the visual saliency data includes the saliency corresponding to each pixel in each frame of the original image, the data preprocessing may need to be performed on the saliency corresponding to each pixel to obtain the corresponding saliency adjustment factor.

In some embodiments, data preprocessing may include Gaussian blur and normalization, which is not limited in the present disclosure. It can be understood that performing Gaussian blur is beneficial to smoothing the edges of the salient area and the non-salient area, thereby ensuring the continuity of the salient area and the non-salient area, and improving the display effect of the image. By performing normalization processing, the saliency value range corresponding to each pixel is between 0 and 1, not between 0 and 255, thereby reducing a certain amount of calculation and improving processing efficiency.

The following description takes Gaussian blur and normalization processing as an example to illustrate the process of data preprocessing.

Assume that the salient image corresponding to the original image img_src of a certain frame is org_sal. By first performing Gaussian blur and then normalization on the salient image org_sal, the saliency adjustment factor of sal=cv2.GaussianBlur (org_sal, (blur1,blur2), sigmaX).astype (np.float64)/255.0 the original image img_src can be obtained. Here, cv2.GaussianBlur is the Gaussian filter function, and the org_sal represents the image that needs to be filtered. The image consists of the saliency corresponding to each pixel in the original image img_src, that is, the salient image of the original image img_src. (blur1,blur2) represents the size of the Gaussian kernel, and sigmaX represents the standard deviation in the horizontal direction. The values of each parameter are not limited in the present disclosure and can be set based on actual needs. For example, the value of (blur1,blur2) can be set to (0,0), and the value of sigmaX can be set to 2. Therefore, after the data preprocessing described above, the value range of the saliency adjustment factor corresponding to each pixel in each frame of the original image is [0,1].

In some embodiments, determining the enhanced image and weakened image corresponding to each frame of the original image may include: performing image quality enhancement processing on the entirety of each frame of the original image to obtain the corresponding enhanced image, and performing image quality weakening processing on the entirety of each frame of the original image to obtain the corresponding weakened image.

It should be noted that the enhanced image and weakened image may have the same size as the original image. The implementation of the image quality enhancement processing and image quality weakening processing has been described in the foregoing embodiments and will not be repeated here.

In some embodiments, after obtaining the enhanced image and weakened image corresponding to each frame of the original image, based on the saliency adjustment factor of each frame of the original image, the second pixel weight corresponding to each frame of the enhanced image and the third pixel weight corresponding to each frame of the weakened image may be determined. Subsequently, based on the second pixel weight and the third pixel weight, the first pixel weight corresponding to each frame of the original image may be determined. In some embodiments, the second pixel weight corresponding to the enhanced image may represent the second pixel weight corresponding to each pixel in the enhanced image, and the third pixel weight corresponding to the weakened image may represent the third pixel weight corresponding to each pixel in the weakened image.

In some embodiments, the second pixel weight and the third pixel weight may be obtained by differential binarization of the saliency adjustment factor, where the sum of the weights of the first pixel weight, the second pixel weight, and the third pixel weight may be 1. The process of determining the weight of each pixel will be described below.

Assume that after obtaining the enhanced image img_ehn and the weakened image img_blur corresponding to the original image img_src, the second pixel weight c_enh corresponding to the enhanced image img_enh and the third pixel weight c_blur corresponding to the weakened image are determined based on the saliency adjustment factor sal corresponding to each pixel in the original image img_src.

In some embodiments, based on a processing method set in advance, binarization processing can be performed on the saliency adjustment factor to obtain the second pixel weight c_enh=cv2.threshold (sal−0.2, 0, 0.8, cv2.THRESH_TOZERO)[1]/0.8 corresponding to the enhanced image img_enh, where cv2.threshold( ) is the image binarization function, sal−0.2 represents the image that needs to be processed, the image being composed of the saliency adjustment factor corresponding to each pixel in the original image img_scr minus 0.2, 0 is the starting threshold, and 0.8 is the maximum value. cv2.THRESH_TOZERO indicates that the value of (sal−0.2) greater than 0 remains unchanged, the value of (sal−0.2) less than 0 is set to 0, and the maximum value is 0.8. The parameter values (such as 0, 0.2, and 0.8) involved in the second pixel weight c_enh expression may be determined based on the actual situation, which is not limited in the embodiments of the present disclosure.

In some embodiments, based on another processing method set in advance, binarization processing can be performed on the saliency adjustment factor to obtain the third pixel weight c_blur=(0.2−cv2.threshold (sal, 0.2, 0.2, cv2.THRESH_TRUNC)[1])/0.2 corresponding to the weakened image img_blur, where sal represents the image that needs to be processed, the image being composed of the saliency adjustment factor corresponding to each pixel in the original image img_src, 0 is the starting threshold, and 0.2 is the maximum value. cv2.THRESH_TRUNC indicates that the sal value is set to 0.2 if it is greater than 0.2, and remains unchanged if it is less than 0.2. The parameter values involved in the third pixel weight c_blur expression may be correspondingly determined based on the second pixel weight c_enh expression.

Based on the above description, it can be seen that for the enhanced image, the value of the saliency adjustment factor is positively correlated with the value of the second pixel weight, indicating that the higher the saliency of the pixels in the enhanced image, the greater the pixel weight; for the weakened image, the value of the saliency adjustment factor is negatively correlated to the value of the third pixel weight, indicating that the lower the saliency of the pixels in the weakened image, the greater the pixel weight. By determining the pixel weight of each pixel with different degrees of saliency through the saliency adjustment factor, the distinction between the salient areas and the non-salient areas can be clearer.

In some embodiments, since the sum of the weights of the first pixel weight, the second pixel weight and the third pixel weight is 1, therefore, after obtaining the second pixel weight c_enh corresponding to the enhanced image img_enh and the third pixel weight c_blur corresponding to the weakened image img_blur, the first pixel weight c_src=1.0-c_enh-c_blur can be obtained.

In addition, after obtaining the first pixel weight c_src, the second pixel weight c_enh and the third pixel weight c_blur, based on these pixel weights, the original image img_src, the enhanced image img_enh and the weakened image img_blur can be weighted and summed to obtain the final image result, where result=img_enh*c_enh+img_blur*c_blur+c_src*img_src. Here, the final image result is the processed target image. Therefore, at least one frame of the processed target image can be obtained corresponding to at least one frame of the original image.

It should be noted that the embodiments of the present disclosure are not limited to the pixel weight determination method described above, and other methods capable of determining pixel weights may also be used, as long as the difference in pixel weights of pixels with different saliency in the enhanced image and the weakened image can be reflected.

Consistent with the present disclosure, after performing overall image quality enhancement and weakening processing on the original image to obtain the corresponding enhanced image and weakened image, the pixel weights corresponding to each image can be respectively determined. More specifically, for the enhanced image, by setting the pixel weight of each pixel with high saliency (such as the highest saliency and medium saliency) in the image to a higher level, and setting the pixel weight of each pixel with low saliency (low saliency or no saliency) to a lower level, the image quality enhancement effect in the salient area can be improved. Correspondingly, for the weakened image, by setting the pixel weights of each pixel with high saliency (such as the highest saliency and medium saliency) to a lower level, and setting the pixel weight of each pixel with low saliency (low saliency or no saliency) to a higher level, the image quality weakening effect in the non-salient area can be improved. By using these pixel weights for image fusion, the effect of enhancing the quality of salient areas and weakening the quality of the non-salient areas in the fused image can be achieved. In this way, the distinction between the two areas can be more distinct, thereby improving the visual effect.

104, encoding the processed target image.

In the embodiments of the present disclosure, after obtaining at least one frame of the processed target image based on the steps above, encoding the processed target image may include: obtaining a first quantization parameter and a second quantization parameter of the processed target image; for the salient area in the target image, using the first quantization parameter to perform encoding processing; and for the non-salient areas in the target image, using the second quantization parameter for encoding processing.

For the process of determining the salient areas and the non-salient areas in the target image based on the visual saliency data or salient images, reference can made to the determination process of the salient areas and other image areas described above, which will not be repeated here. When encoding the target image, different quantization parameters may be used in the salient areas and the non-salient areas respectively. The value of the first quantization parameter used in the salient area may be smaller than the value of the second quantization parameter used in the non-salient areas. After obtaining each frame of the encoded target image, the encoded target image can be transmitted through the network.

It should be understood that, since the smaller the value of the quantization parameter, the higher the quantization accuracy, in the embodiments of the present disclosure, the first quantization parameter with a relatively large value may be used to encode the salient area in the target image of each frame to ensure that most of the image details in the salient areas are retained and to reduce coding distortion, and the second quantization parameter with a relatively small value may be used to encode the non-salient areas. In this way, the salient areas can obtain more bit rates and the non-salient areas can obtain less bit rates under the bit rate constraints, thereby improving the visual quality of the encoded image.

Consistent with the present disclosure, the data processing method includes: obtaining at least one frame of the original image; performing visual saliency detection on each original image in at least one frame of original images to obtain visual saliency data of each original image; based on the visual saliency data, performing differential processing on different locations of each frame of the original image to obtain at least one processed target image; and encoding the processed target image. Here, each frame of the original image acquired can be regarded as any original video image in the video conferencing scenario. In the embodiments of the present disclosure, the corresponding visual saliency data can be obtained by performing visual saliency detection on each frame of the original image, and then the saliency detection data can be used as a guide to perform differential processing on different locations of the original image. For example, image quality enhancement processing may be performed on the area of interest to the user in the original image, that is, the salient area, and no special processing may be performed on other areas, or image quality weakening processing may be performed. In this way, the image quality of the salient area in each frame of the original image can be improved and the visual quality of the encoded image can be ensured, thereby address the reduced image quality after encoding due to low network bandwidth in video conferencing scenarios, and effectively improving the visual experience of end users.

In order to better illustrate the purpose of the present disclosure, based on the foregoing embodiments, further explanation is provided for the video conferencing scenario.

FIG. 4 is a flowchart of another data processing method according to an embodiment of the present disclosure. The method will be described in detail below.

201, receiving a YUV sequence of an input video.

In some embodiments, the input video may be any video segment in the video conference scenario. The YUV sequence may include a plurality of frames of video images in the video segment, and the format of each frame of video images is in the YUV format. It should be noted that the format of the video image may also be other formats, such as RGB (red, green, blue) format, RAW format, etc., which is not limited in the present disclosure.

202, performing visual saliency detection on the YUV sequence.

In some embodiments, the visual saliency model based on deep learning may be used to detect the visual saliency of the YUV sequence to obtain the saliency images corresponding to each frame of the video image in the YUV sequence.

203, preprocessing each frame of the video image based on the saliency image.

The preprocessing may correspond to the differential processing described above. First, the salient areas and the non-salient areas in each frame of the video image may be determined based on the saliency of each pixel in the saliency image. Subsequently, image quality enhancement processing may be performed on the salient areas in each frame of the video image, and image quality weakening processing may be performed on the non0salinet areas in each frame of the video image.

204, encoding each frame of the preprocessed video image.

Each frame of the video image after preprocessing may correspond to each frame of the target image after the above processing. The first quantization parameter corresponding to the salient areas and the second quantization parameter corresponding to the non-salient areas in each frame of the preprocessed video image may be obtained. The salient areas may be encoded by using the first quantization parameter with a relatively large value, and the non-salient areas may be encoded by using the second quantization parameter with a relatively small value. Lastly, each frame of the encoded video image may be transmitted through the network.

Consistent with the present disclosure, before encoding each frame of the video image in a video conferencing scenario, the visual saliency model can be used to perform image preprocessing that includes enhancement processing of the salient areas and weakening processing of the non-salient areas. In this way, the coding quality of the salient areas of each frame of the video image can be improved under the bit rate constraints, thereby improving the visual experience of end users.

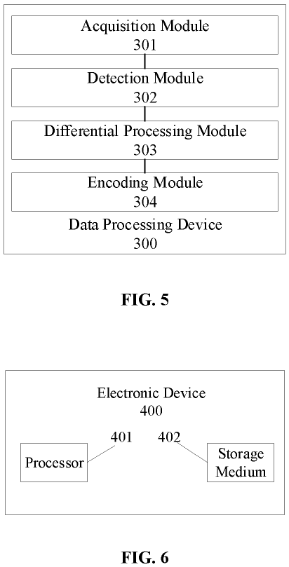

FIG. 5 is a schematic structural diagram of a data processing device 300 according to an embodiment of the present disclosure. As shown in FIG. 5, the data processing device 300 includes an acquisition module 301, a detection module 302, a differential processing module 303, and an encoding module 304.

In some embodiments, the acquisition module 301 may be configured to obtain at least one frame of the original image.

In some embodiments, the detection module 302 may be configured to perform visual saliency detection on each frame of the original image in the at least one frame of the original image to obtain the visual saliency data of each frame of the original image.

In some embodiments, the differential processing module 303 may be configured to perform differential processing on different locations of each frame of the original image based on the visual saliency data to obtain at least one frame of the processed target image.

In some embodiments, the encoding module 304 may be configured to encode the processed target image.

In some embodiments, the differential processing module 303 may be configured to divide each frame of the original image into areas to obtain a plurality of image areas based on the visual saliency data; perform differential image quality adjustment processing on different image areas in the plurality of image areas to obtain a plurality of processed image areas; and obtain at least one frame of the processed target image based on the plurality of processed image areas.

In some embodiments, the plurality of image areas may include at least one salient area, and the differential processing module 303 may be configured to perform image quality enhancement processing on the at least one salient area, and image quality weakening processing or no processing on other image areas.

In some embodiments, the data processing device may also include a fusion module. The fusion module may be configured to perform image fusion processing on the plurality of processed image areas to obtain at least one frame of fused image, the edge continuity between each image area in the fused image meeting a set requirement; and determine the fused image of each frame as the processed target image.

In some embodiments, the differential processing module 303 may be configured to determine the saliency adjustment factor of each frame of the original image based on the visual saliency data; determine the enhanced image and weakened image corresponding to each frame of the original image; determine the first pixel weight corresponding to each frame of the original image, the second pixel weight corresponding to each frame of the enhanced image, and the third pixel weight corresponding to each frame of the weakened image based on the saliency adjustment factor of each frame of the original image; and calculate a weighted sum of each frame of the original image, each frame of the enhanced image, and each frame of the weakened image to obtain at least one processed target image based on the first pixel weight, the second pixel weight, and the third pixel weight.

In some embodiments, the second pixel weight and the third pixel weight may be obtained by performing differential binarization processing on the saliency adjustment factor. The sum of the weights of the first pixel weight, the second pixel weight, and the third pixel weight is 1.

In some embodiments, the difference in image bit rate before and after each frame of the original image is differentiated may be less than the set threshold.

In some embodiments, the detection module 302 may be configured to input each frame of the original image into a pre-trained visual saliency model for visual saliency detection to obtain the visual saliency data of each frame of the original image, the visual saliency model being trained based on the saliency data set collected by the visual acquisition device and the pseudo-saliency data set.

In some embodiments, the encoding module 304 may be configured to obtain the first quantization parameter and the second quantization parameter of the target image, the value of the first quantization parameter being smaller than the second quantization parameter; using the first quantization parameter to perform encoding processing on the salient areas in the target image; and using the second quantization parameter to perform encoding processing on the non-salient areas in the target image.

In embodiments of the present application, the acquisition module 301, detection module 302, differential processing module 303, encoding module 304, and fusion module can all be implemented by a processor located in an electronic device. The processor can be at least one of an ASIC, a DSP, a DSPD, a PLD, an FPGA, a CPU, a controller, a microcontroller, and a microprocessor.

In addition, each functional unit or functional module in each embodiment of the present disclosure may be integrated into one processing unit, each unit may exist physically alone, or two or more units may be integrated into one unit. The integrated unit may be implemented in the form of hardware or in the form of software functional units.

If the integrated unit is implemented in the form of a software function unit and sold or used as an independent product, it can be stored in a computer readable storage medium. Based on such understanding, the technical solution of the present disclosure, in essence or in the form of a software product, which is stored in a storage medium, includes several instructions for making a computer device (which can be a personal computer, a server, a network device, etc.) or a processor to perform all or part of the steps of the method according to each embodiment of the present disclosure. The aforementioned storage media include flash drive, mobile hard disk, read-only memory (ROM), random access memory (RAM), disk or optical disk and other media that can store program code.

Specifically, the computer program instructions corresponding to the data processing method provided in the embodiments of the present disclosure can be stored on a storage medium such as an optical disk, a hard disk, a flash drive, etc. When the computer program instructions corresponding to the data processing method in the storage medium are read or executed by an electronic device, the data processing method described in the foregoing embodiments can be implemented.

Descriptions of apparatus embodiments of this disclosure are similar to the descriptions of the foregoing method embodiments. The apparatus embodiments have beneficial effects similar to those of the method embodiments and thus are not repeatedly described. Refer to descriptions in the method embodiments of this disclosure for technical details undisclosed in the apparatus embodiments of this disclosure.

An embodiment of the present disclosure provides an electronic device. FIG. 6 is a schematic structural diagram of an electronic device 400 according to an embodiment of the present disclosure. As shown in FIG. 6, electronic device 400 includes a processor 401 and a computer-readable storage medium 402 configured to store executable instructions. The processor 401 generally controls the overall operation of the electronic device. The computer-readable storage medium 402 may be configured to store instructions and applications executable by the processor 401, and may also cache data to be processed or processed by each module in the processor 401 and the electronic device 400, which can be implemented through a flash or a RAM.

An embodiment of this application provides a storage medium storing executable instructions, the executable instructions, when executed by a processor, causing the processor to perform the method, for example, the method as shown in FIG. 1 provided in the embodiments of the present disclosure.

In some embodiments, the computer-readable storage medium can include a memory such as ferromagnetic random-access memory (FRAM), read-only memory (ROM), programmable read-only memory (PROM), erasable programmable read-only memory (EPROM), electronically erasable programmable read-only memory (EEPROM), flash, magnetic surface memory, optical disk, or compact disk-read-only memory (CD-ROM), or various apparatuses including one or any combination thereof.

In some embodiments, the executable instructions can be written in any form of programming language (including compiled or interpreted languages) in a form of a program, a software module, a script, or codes, and can be deployed in any form, including as a stand-alone program or as a module, assembly, subroutine, or another unit suitable for use in a computing environment.

In an example, the executable instructions may, but do not necessarily, correspond to a file in a file system, and may be stored in a part of a file that saves another program or other data, for example, be stored in one or more scripts in a hypertext markup language (HTML) file, stored in a file that is specially used for a program in discussion, or stored in the plurality of collaborative files (for example, be stored in files of one or modules, subprograms, or code parts). For example, the executable instructions can be deployed and executed on one computer apparatus or on a plurality of computer apparatuses at one place or distributed across a plurality of places and interconnected by a communication network.

The foregoing descriptions are merely embodiments of this application and are not intended to limit the protection scope of this application. Any modification, equivalent replacement, or improvement made without departing from the spirit and range of this application shall fall within the protection scope of this application.

A person skilled in the art should appreciate that the term “one embodiment” or “an embodiment” referenced in the full text means that the particular characteristics, structures, or features relevant to the embodiment are included in at least one embodiment of the present disclosure. Therefore, the term “in one embodiment” or “in an embodiment” in this description do not necessarily refer to the same embodiment. In addition, the described characteristics, structures, or features may be incorporated in one or more embodiments in any suitable manner. It should be appreciated that in various embodiments of the present disclosure, the sequence numbers of the above various processes or steps do not denote a preferred sequence of performing the processes or steps. Furthermore, the sequence of performing the processes and steps should be determined according to the functions and internal logics thereof, which shall not constitute any limitation to the implementation process of the embodiments of the present disclosure. The sequence numbers of the embodiments of the present disclosure are merely for the ease of description, and do not denote the preference of the embodiments.

It should be noted that, in this text, the terms “comprise”, “comprising”, “has”, “having”, “include”, “including”, “contain”, “containing” or any other variation thereof, are intended to cover a non-exclusive inclusion, such that a process, method, article, or apparatus that comprises, has, includes, contains a list of elements, not only include those elements, but also may include other elements not expressly listed or inherent to such process, method, article, or apparatus. An element proceeded by “comprise . . . a”, “has . . . a”, “include . . . a”, “contain . . . a” does not, without more constraints, preclude the existence of additional identical elements in the process, method, article, or apparatus.

In the several embodiments provided in the present disclosure, it should be understood that the disclosed device and method may be realized in other manners. The above described device embodiments are merely illustrative. For example, unit division is merely a method of logical function division and may be other methods of division in actual practice. For example, multiple units or components may be combined or integrated into another system, or some features can be ignored or not performed.

The above embodiments are used only for illustrating the present disclosure, but not intended to limit the protection scope of the present disclosure. Various modifications and replacements readily derived by those skilled in the art within technical disclosure of the present disclosure shall fall within the protection scope of the present disclosure. Accordingly, the protection scope of the present disclosure is defined by the claims.

What is claimed is:

1. A data processing method comprising:
obtaining at least one frame of an original image;
performing visual saliency detection on each frame of the at least one frame of the original image to obtain visual saliency data of each frame of the original image;
performing differential processing on different positions of each frame of the original image to obtain at least one frame of a processed target image based on the visual saliency data; and
encoding the processed target image.

2. The method of claim 1, wherein performing the visual saliency detection on each frame of the original image in the at least one frame of the original image to obtain the visual saliency data of each frame of the original image based on the visual saliency data includes:
dividing each frame of the original image into areas to obtain a plurality of image areas based on the visual saliency data;
performing differential image quality adjustment processing on different image areas in the plurality of image areas to obtain a plurality of processed image areas; and
obtaining at least one frame of processed target image based on the plurality of processed image areas.

3. The method of claim 2, wherein:
the plurality of image areas includes at least one salient area, and performing the differential image quality adjustment processing on different image areas in the plurality of image areas includes:
performing image quality enhancement processing on the at least one salient area, and image quality weakening processing or no processing on other image areas, the other image areas being each image area in the plurality of image areas other than the salient area.

4. The method of claim 2, wherein obtaining at least one frame of processed target image based on the plurality of processed image areas includes:
performing image fusion processing on the plurality of processed image areas to obtain at least one frame of fused image, an edge continuity between each image area in the fused image meeting a set requirement; and
determining each frame of the fused image as the processed target image.

5. The method of claim 1, wherein performing the visual saliency detection on each frame of the original image in the at least one frame of the original image to obtain the visual saliency data of each frame of the original image based on the visual saliency data includes:
determining a saliency adjustment factor of each frame of the original image based on the visual saliency data;
determining an enhance image and a wakened image corresponding to each frame of the original image;
determining a first pixel weight corresponding to each frame of the original image, a second pixel weight corresponding each frame of the enhanced image, and a third pixel weight corresponding to each frame of the weakened image based on the saliency adjustment factor of each frame of the original image; and
calculating a weighted sum of each frame of the original image, each frame of the enhanced image, and each frame of the weakened image to obtain at least frame of the processed target image based on the first pixel weight, the second pixel weight, and the third pixel weight.

6. The method of claim 5, wherein:
the second pixel weight and the third pixel weight are obtained by performing differential binarization on the saliency adjustment factor, and
the sum of weights of the first pixel weight, the second pixel weight, and the third pixel weight is 1.

7. The method of claim 1, wherein:
a difference in image bit rates before and after the differential processing of each frame of the original image is less than a set threshold.

8. The method of claim 1, wherein performing the visual saliency detection on each frame of the original image to obtain the visual saliency data of each frame of the original image includes:
inputting each frame of the original image into a pre-trained visual saliency model for the visual saliency detection to obtain the visual saliency data of each frame of the original image, the visual saliency model being trained based on a saliency data set collected by a visual acquisition device and a pseudo-saliency data set.

9. The method of claim 1, wherein encoding the processed target image includes:
obtaining a first quantization parameter and a second quantization parameter of the target image, a first quantization parameter value being smaller than a second quantization parameter value;
using the first quantization parameter for the encoding processing of the salient area in the target image; and
using the second quantization parameter value for encoding processing of non-salient areas in the target image.

10. A data processing device, applied to an electronic device, comprising:
an acquisition module, the acquisition module being configured to obtain at least one frame of an original image;
a detection module, the detection module being configured to perform visual saliency detection on each frame of the at least one frame of the original image to obtain visual saliency data of each frame of the original image;
a differential processing module, the differential processing module being configured to perform differential processing on different positions of each frame of the original image to obtain at least one frame of a processed target image based on the visual saliency data; and
an encoding module, the encoding module being configured to encode the processed target image.

11. The device of claim 10, wherein the differential processing module is further configured to:
divide each frame of the original image into areas to obtain a plurality of image areas based on the visual saliency data;
perform differential image quality adjustment processing on different image areas in the plurality of image areas to obtain a plurality of processed image areas; and
obtain at least one frame of processed target image based on the plurality of processed image areas.

12. The device of claim 11, wherein:
the plurality of image areas includes at least one salient area, and the differential processing module is further configured to:
perform image quality enhancement processing on the at least one salient area, and image quality weakening processing or no processing on other image areas, the other image areas being each image area in the plurality of image areas other than the salient area.

13. The device of claim 10, wherein the differential processing module is further configured to:
determine a saliency adjustment factor of each frame of the original image based on the visual saliency data;
determine an enhance image and a wakened image corresponding to each frame of the original image;
determine a first pixel weight corresponding to each frame of the original image, a second pixel weight corresponding each frame of the enhanced image, and a third pixel weight corresponding to each frame of the weakened image based on the saliency adjustment factor of each frame of the original image; and
calculate a weighted sum of each frame of the original image, each frame of the enhanced image, and each frame of the weakened image to obtain at least frame of the processed target image based on the first pixel weight, the second pixel weight, and the third pixel weight.

14. The device of claim 13, wherein:
the second pixel weight and the third pixel weight are obtained by performing differential binarization on the saliency adjustment factor, and
the sum of weights of the first pixel weight, the second pixel weight, and the third pixel weight is 1.

15. The device of claim 10, wherein:
a difference in image bit rates before and after the differential processing of each frame of the original image is less than a set threshold.

16. The device of claim 10, wherein the detection module is further configured to:
input each frame of the original image into a pre-trained visual saliency model for the visual saliency detection to obtain the visual saliency data of each frame of the original image, the visual saliency model being trained based on a saliency data set collected by a visual acquisition device and a pseudo-saliency data set.

17. The device of claim 10, wherein the encoding module is further configured to:
obtain a first quantization parameter and a second quantization parameter of the target image, a first quantization parameter value being smaller than a second quantization parameter value;
use the first quantization parameter for the encoding processing of the salient area in the target image; and
use the second quantization parameter value for encoding processing of non-salient areas in the target image.

18. A computer readable storage medium, storing computer instructions, when executed by one or more processors, the computer instructions perform a data processing method comprising:
obtaining at least one frame of an original image;
performing visual saliency detection on each frame of the at least one frame of the original image to obtain visual saliency data of each frame of the original image;
performing differential processing on different positions of each frame of the original image to obtain at least one frame of a processed target image based on the visual saliency data; and
encoding the processed target image.

19. The computer readable storage medium of claim 18, wherein performing the visual saliency detection on each frame of the original image in the at least one frame of the original image to obtain the visual saliency data of each frame of the original image based on the visual saliency data includes:
dividing each frame of the original image into areas to obtain a plurality of image areas based on the visual saliency data;
performing differential image quality adjustment processing on different image areas in the plurality of image areas to obtain a plurality of processed image areas; and
obtaining at least one frame of processed target image based on the plurality of processed image areas.

20. The computer readable storage medium of claim 19, wherein:
the plurality of image areas includes at least one salient area, and performing the differential image quality adjustment processing on different image areas in the plurality of image areas includes:
performing image quality enhancement processing on the at least one salient area, and image quality weakening processing or no processing on other image areas, the other image areas being each image area in the plurality of image areas other than the salient area.
